(19) United States
(12) Patent Application Publication
(10) Pub. No.: US 2026/0013418 A1
(43) Pub. Date: Jan. 15, 2026

(54) AGRICULTURAL PLANTER TO CLOSE A SEED TRENCH

(71) Applicant: Anthony R. Wendler, Armstrong, IA (US)

(72) Inventor: Anthony R. Wendler, Armstrong, IA (US)

(21) Appl. No.: 19/333,403

(22) Filed: Sep. 19, 2025

Related U.S. Application Data
(63) Continuation-in-part of application No. 17/216,691, filed on Mar. 30, 2021, now Pat. No. 12,439,842.

(51) Int. Cl. A01C 5/06

(52) U.S. Cl. CPC A01C 5/068

(57) ABSTRACT

Disclosed are a method, a system, and an apparatus of an agricultural planter to close a seed trench. In one embodiment, a closing wheel assembly for an agricultural planter includes a spiked wheel frame and a shoulder frame. The spiked wheel frame has a series of outwardly projected radial teeth configured to penetrate a soil to close a seed trench. The shoulder frame situated adjacent to the spiked wheel frame is formed using a one or more pieces of steel and is securely mounted onto a closing wheel hub. The shoulder frame displaces the soil towards the seed trench to close the seed trench formed by the spiked wheel frame as the closing wheel assembly rotates. The closing wheel assembly rotates through the soil to cover a seed by forming a soil layer around the seed for germination. The shoulder frame is radially welded adjacent to the spiked wheel frame.

### CLAIM OF PRIORITY

This application is a U.S. Utility Continuation-In-Part patent application of U.S. Utility patent application Ser. No. 17/216,691 titled CLOSING WHEEL OF A PLANTER USING A SET OF INTERLOCKING ARCHES TO ENSURE OPTIMUM SOIL-TO-SEED CONTACT filed on Mar. 30, 2021, which further claims priority to U.S. Provisional Patent Application No. 63/001,547 titled METHOD AND SYSTEM OF FORMING A CLOSING WHEEL OF A PLANTER USING A SET OF INTERLOCKING ARCHES TO ENSURE OPTIMUM SOIL-TO-SEED CONTACT FOR CONSISTENT GERMINATION AND EMERGENCE OF A CROP filed on Mar. 30, 2020. The contents of the applications mentioned above are incorporated by reference in their entirety thereof.

### FIELD OF TECHNOLOGY

This disclosure relates generally to the field of planting equipment, and, more particularly, to a method, a system, and an apparatus of an agricultural planter to close a seed trench.

### BACKGROUND

An agricultural crop may be planted using a planter. The planter may open a furrow in a soil and place a seed in the furrow. A closing wheel may further be used at the back of the planter to press on the soil at the sides and/or top of the seed furrow to cover the seed with soil. Pressure may be employed on the packing and/or closing wheels to compress and/or fracture the furrow sidewalls back. However, this may result in a poor seedling emergence since the seedlings may have inadequate soil coverage and/or have difficulty pushing itself through a dense layer of the soil. In addition, the roots may be unable to penetrate through the compacted sidewalls resulting in poor root formation. This may result in undesirable low yield.

The closing wheel may be made of rubber-tired, plastic, cast iron, and/or other cast metals. The closing wheel made of steel may not have sufficient width provided to its teeth. The inadequate width of the closing wheel and its teeth may not displace sufficient amount of the soil to be effective. Further, inadequate width of the closing wheel and its teeth may be inefficient to cover the seed appropriately. The steel closing wheel may need to be cut-out from a workpiece. The circular workpiece may further be machine finished and cut at the center to be able to be fitted onto a standard closing wheel rim and bearing set. This process of cutting the steel at the center of the wheel may result in wasting a lot of steel, making it expensive, especially when using a proper width of material and/or the workpiece. The finishing and machining of the closing wheel, prior to affixing it onto the standard closing wheel rim and bearing set, may require higher tool efficiency and may be uneconomical. The rubber-tired and/or plastic closing wheel may be ineffective in varying tillage and soil conditions. The rubber-tired and/or the plastic closing wheel may wear out easily and require early replacement.

### SUMMARY

Disclosed are a method, a system, and an apparatus of an agricultural planter to close a seed trench.

In one aspect, a closing wheel assembly for an agricultural planter includes a spiked wheel frame and a shoulder frame. The spiked wheel frame has a series of outwardly projected radial teeth. The series of outwardly projected radial teeth is configured to penetrate a soil to close a seed trench. The spiked wheel frame is formed using a one or more pieces of steel. The shoulder frame is situated adjacent to the spiked wheel frame to securely mount onto a closing wheel hub. The shoulder frame displaces the soil towards the seed trench to close the seed trench. The seed trench is formed by the spiked wheel frame as the closing wheel assembly rotates. The closing wheel assembly rotates through the soil to cover a seed by forming a soil layer around the seed for germination. The shoulder frame is radially welded adjacent to the spiked wheel frame to form the closing wheel assembly.

The closing wheel assembly may be analogous to fingers representing the radial teeth of the spiked wheel frame. The radial teeth of the spiked wheel frame may slide down a “V” shape to displace the soil toward a furrow. The thumbs may represent the shoulder frame moving in coordination to gather the soil and/or pinch it between each other. The combined action may uniquely create a firm vein of soil at the bottom of the furrow around the seed.

The closing wheel assembly may produce more than 1 kg per square centimeter in a firmness directly around and/or slightly above the seed as measured by penetrometer. The shoulder frame may be configured to form a circular object to displace the soil towards the seed trench. The shoulder frame may enable seed-to-soil contact following the soil layer formed around the seed by the displaced soil to eliminate sidewall compaction through soil firming, air pockets, and close the seed trench with an inner rim shoulder firming.

The spiked wheel frame of the closing wheel assembly may be configured to have a width, a shape, and a length of the outward projections of the radial teeth modified depending on a soil condition and/or a crop requirement. The spiked wheel frame and the shoulder frame may be a cut steel, a molded steel, a molded plastic, a forged steel, and/or a forged metal.

The shoulder frame may be formed by modifying a width and a depth depending on the soil condition and/or the crop requirement. An outermost edge of the shoulder frame may be configured to align with a base of the radial teeth of the spiked wheel frame. The width of the radial teeth may be half of an inch and the width of the shoulder frame may be ⅜th of an inch to displace the soil for a corn crop, a sunflower crop, a bean crop and/or a sorghum crop.

The width of the radial teeth may be approximately half of an inch and the width of the shoulder frame. The width of the shoulder frame may be approximately a half an inch, and a spike length may be shortened to displace the soil for a bean crop, a cotton crop, a legume crop, and/or a sugar beet crop. The width of the radial teeth and the width of the shoulder frame may be optimized based on a crop type.

In another aspect, a method of closing a seed trench in a field includes providing a closing wheel assembly. The closing wheel assembly includes a spiked wheel frame having a series of outwardly projected radial teeth and a shoulder frame. The shoulder frame is situated adjacent to the spiked wheel frame. The shoulder frame is secured to the spiked wheel frame by radial welds. The shoulder frame is configured to mount to a closing wheel hub. The closing wheel assembly is mounted on an agricultural planter. The closing wheel assembly rotates through a soil alongside a seed trench by advancing the planter. The soil is penetrated with the radial teeth to displace the soil toward the seed trench. The shoulder frame is used to gather the displaced soil toward the seed trench and/or form the soil layer that covers a seed to promote germination.

The closing wheel assembly may operate in coordination with an opposing closing wheel assembly on opposite sides of a “V” shaped furrow such that the radial teeth slide down respective sidewalls of the “V” to pull the soil inward and the shoulder frames move in concert to gather the soil and/or pinch it between the assemblies, thereby creating a firm vein of soil at or near the bottom of the furrow around the seed. The method of closing a seed trench in a field may produce a firmness of more than 1 kg/cm² directly around and/or slightly above the seed, as measured by penetrometer. The shoulder frame may present a circular shoulder. The circular shoulder displaces the soil toward the seed trench during rotation to establish seed-to-soil contact. The circular shoulder may eliminate sidewall compaction by firming the soil inward, reduce air pockets, and complete the seed trench closure with an inner-rim shoulder firming.

The method of closing a seed trench in a field may include selecting a width, a shape, and a length of the outward projections of the radial teeth based on a soil condition and/or a crop requirement. The spiked wheel frame may be formed of one or more pieces of steel and the shoulder frame may be radially welded adjacent thereto to form the closing wheel assembly. The spiked wheel frame and the shoulder frame may include a material selected from a cut steel, a molded steel, a molded plastic, a forged steel, and/or a forged metal.

The method of closing a seed trench in a field may include selecting a width and a depth of the shoulder frame based on the soil condition and/or the crop requirement. An outermost edge of the shoulder frame may be aligned with a base of the radial teeth of the spiked wheel frame.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a closing wheel assembly of a planter fabricated using a set of interlocking arches and a shoulder frame to optimally displace the soil to cover the seed while planting, according to one embodiment.

FIG. 2 is an exploded view of the closing wheel assembly of FIG. 1 illustrating the constituting components of the closing wheel assembly, according to one embodiment.

FIG. 3 is an exploded view of the closing wheel of the closing wheel assembly of FIG. 1 illustrating the interlinking of the arch-shaped interlocking segments to precisely secure with the adjacent segment to form the closing wheel, according to one embodiment.

FIG. 4 is a conceptual view illustrating the functioning of the closing wheel assembly of FIG. 1 to optimally cover the seed while planting, according to one embodiment.

FIG. 5 is a schematic view of the closing wheel assembly of FIG. 1, illustrating a direction of rotation of the assembly and the cooperative action of the radial teeth and shoulder frame, according to one embodiment.

FIG. 6 is a conceptual view of the closing wheel assembly of FIG. 1, illustrating the formation of a pinch zone and a firm soil vein around the seed by the cooperative action of the radial teeth and the inner rim shoulder frame to enhance seed-to-soil contact and improve germination, according to one embodiment.

Other features of the present embodiments will be apparent from the accompanying drawings and from the detailed description that follows.

### DETAILED DESCRIPTION

Example embodiments, as described below, may be used to provide a method, a system, and an apparatus of an agricultural planter 404 to close a seed trench.

In one embodiment, a closing wheel assembly 102 for an agricultural planter includes a spiked wheel frame 104 and a shoulder frame 106. The spiked wheel frame 104 has a series of outwardly projected radial teeth 110. The series of outwardly projected radial teeth 110 is configured to penetrate a soil 408 to close a seed trench. The spiked wheel frame 104 is formed using a one or more pieces of steel. The shoulder frame 106 is situated adjacent to the spiked wheel frame 104 to securely mount onto a closing wheel hub 114. The shoulder frame 106 displaces the soil 408 towards the seed trench to close the seed trench. The seed trench is formed by the spiked wheel frame 104 as the closing wheel assembly 102 rotates. The closing wheel assembly 102 rotates through the soil 408 to cover a seed 406 by forming a soil layer around the seed 406 for germination. The shoulder frame 106 is radially welded adjacent to the spiked wheel frame 104 to form the closing wheel assembly 102.

The closing wheel assembly 102 may be analogous to fingers 604 representing the radial teeth 110 of the spiked wheel frame 104. The radial teeth 110 of the spiked wheel frame 104 may slide down a “V” shape 502 to displace the soil 408 toward a furrow 402. The thumbs 602 may represent the shoulder frame 106 moving in coordination to gather the soil 408 and/or pinch it between each other. The combined action may uniquely create a firm vein of soil 608 at the bottom of the furrow 402 around the seed 406.

The closing wheel assembly 102 may produce more than 1 kg per square centimeter in a firmness directly around and/or slightly above the seed 408 as measured by penetrometer. The shoulder frame 106 may be configured to form a circular object to displace the soil 408 towards the seed trench. The shoulder frame 106 may enable seed-to-soil contact following the soil layer formed around the seed 406 by the displaced soil 408 to eliminate sidewall compaction through soil firming, air pockets, and close the seed trench with an inner rim 204 shoulder firming.

The spiked wheel frame 104 of the closing wheel assembly 102 may be configured to have a width, a shape, and a length of the outward projections of the radial teeth 110 modified depending on a soil condition and/or a crop requirement. The spiked wheel frame 104 and the shoulder frame 106 may be a cut steel, a molded steel, a molded plastic, a forged steel, and/or a forged metal.

The shoulder frame 106 may be formed by modifying a width and a depth depending on the soil condition and/or the crop requirement. An outermost edge of the shoulder frame 106 may be configured to align with a base of the radial teeth 110 of the spiked wheel frame 104. The width of the radial teeth 110 may be half of an inch and the width of the shoulder frame 106 may be ⅜th of an inch to displace the soil 408 for a corn crop, a sunflower crop, a bean crop and/or a sorghum crop.

The width of the radial teeth 110 may be approximately half of an inch and the width of the shoulder frame 106. The width of the shoulder frame 106 may be approximately a half an inch, and a spike length may be shortened to displace the soil 408 for a bean crop, a cotton crop, a legume crop, and/or a sugar beet crop. The width of the radial teeth 110 and the width of the shoulder frame 106 may be optimized based on a crop type.

In another embodiment, a method of closing a seed trench in a field includes providing a closing wheel assembly 102. The closing wheel assembly 102 includes a spiked wheel frame 104 having a series of outwardly projected radial teeth 110 and a shoulder frame 106. The shoulder frame 106 is situated adjacent to the spiked wheel frame 104. The shoulder frame 106 is secured to the spiked wheel frame 104 by radial welds. The shoulder frame 106 is configured to mount to a closing wheel hub 114. The closing wheel assembly 102 is mounted on an agricultural planter. The closing wheel assembly rotates through a soil 408 alongside a seed trench by advancing the planter 404. The soil 408 is penetrated with the radial teeth 110 to displace the soil 408 toward the seed trench. The shoulder frame 106 is used to gather the displaced soil 408 toward the seed trench and/or form the soil layer that covers a seed 406 to promote germination.

The closing wheel assembly 102 may operate in coordination with an opposing closing wheel assembly on opposite sides of a “V” shaped furrow 402 such that the radial teeth 110 slide down respective sidewalls of the “V” to pull the soil 408 inward and the shoulder frames 106 move in concert to gather the soil 408 and/or pinch it between the assemblies, thereby creating a firm vein of soil 608 at or near the bottom of the furrow 402 around the seed 408. The method of closing a seed trench in a field may produce a firmness of more than 1 kg/cm² directly around and/or slightly above the seed 408, as measured by penetrometer. The shoulder frame 106 may present a circular shoulder. The circular shoulder displaces the soil 408 toward the seed trench during rotation to establish seed-to-soil contact. The circular shoulder may eliminate sidewall compaction by firming the soil 408 inward, reduce air pockets, and complete the seed trench closure with an inner-rim 204 shoulder firming.

The method of closing a seed trench in a field may include selecting a width, a shape, and a length of the outward projections of the radial teeth 110 based on a soil condition and/or a crop requirement. The spiked wheel frame 104 may be formed of one or more pieces of steel and the shoulder frame 106 may be radially welded adjacent thereto to form the closing wheel assembly 102. The spiked wheel frame 104 and the shoulder frame 106 may include a material selected from a cut steel, a molded steel, a molded plastic, a forged steel, and/or a forged metal.

The method of closing a seed trench in a field may include selecting a width and a depth of the shoulder frame 106 based on the soil condition and/or the crop requirement. An outermost edge of the shoulder frame 106 may be aligned with a base of the radial teeth 110 of the spiked wheel frame 104.

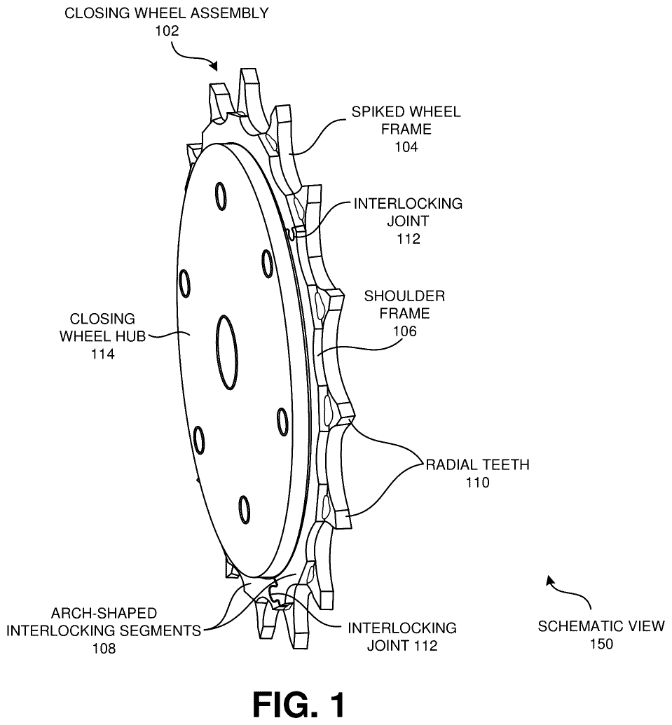

FIG. 1 is a schematic view 150 of a closing wheel assembly 102 of a planter 404 fabricated using a spiked wheel frame 104 and a shoulder frame 106 to optimally displace a soil 408 to cover a seed 406 while planting, according to one embodiment. Particularly, FIG. 1 illustrates the closing wheel assembly 102, the spiked wheel frame 104, the shoulder frame 106, an arch-shaped interlocking segment 108, a radial teeth 110, an interlocking joint 112, and a closing wheel hub 114, according to one embodiment.

The closing wheel assembly 102 may be an assemblage of wheel components having outwardly directed circumferential teething projections and is rotatably mounted at the rear of a planter 404 to displace the soil 408 at the sides of a furrow 402 to gently close the furrow 402 to cover the seed 406 with the soil 408 while planting. A closing wheel 210 may include the six arch-shaped interlocking segments 108 forming the spiked wheel frame 104 and the shoulder frame 106, that are welded together and fitted onto a standard closing wheel rim 208 and bearing sets (e.g., closing wheel hub 114). In addition, the closing wheel assembly 102 may include the shoulder frame 106 fitted onto an inner rim 204 of the closing wheel assembly 102. The closing wheel assembly 102 may be designed to close the seed trench with the inner rim shoulder firming using its shoulder frame 106, according to one embodiment.

In another embodiment, the closing wheel assembly 102 may include the four and/or more arch-shaped interlocking segments 108 forming the closing wheel 210 welded together and fitted onto the standard closing wheel rim 208 and bearing sets (e.g., closing wheel hub 114). The closing wheel hub 114 may include the rim 208, a hub 202, an inner rim 204, and a disc 206.

The spiked wheel frame 104 and the shoulder frame 106 may be a set of two circular metal loops welded together to form the closing wheel assembly 102. The closing wheel 210 may be configured to easily fit onto the standard closing wheel rim 208 and bearing sets. The outer periphery of the closing wheel 210 may come in contact with the soil 408 while planting. The closing wheel 210 may include angular radial teeth 110 designed to penetrate the soil 408 to form the seed trench (e.g., furrow 402), according to one embodiment.

The closing wheel hub 114 may be a circular metal component configured to fit onto the inner rim 204 of the closing wheel assembly 102. The shoulder frame 106 of the closing wheel assembly 102 may be configured to put an appropriate amount of pressure onto the seed 406 and cover the soil 408 around the seed 406 to get the best seed-to-soil contact.

According to one embodiment, the arch-shaped interlocking segments 108 may be a set of three interconnecting metal bow-shaped sections that may be joined to form the closing wheel 210. In another embodiment, the arch-shaped interlocking segments 108 may be a set of two and/or more interconnecting metal bow-shaped sections that may be joined to form the closing wheel 210. The arch-shaped interlocking segments 108 may have a puzzle element 302 and a puzzle slot 304 at either of its ends that may precisely engage with the adjacent member to form a circular loop, without welding.

The larger circular loop forming the inner band of the spiked wheel frame 104, having the radial teeth 110 of the closing wheel 210, may be configured using three larger pieces of the arch-shaped interlocking segments 108 having the radial teeth 110. The smaller outer band of the shoulder frame 106 of the closing wheel 210 may be formed using three smaller pieces of the arch-shaped interlocking segments 108. The three larger pieces of the arch-shaped interlocking segments 108 forming the spiked wheel frame 104 having the radial teeth 110 may be of half-inch thick steel, and the three smaller pieces of arch-shaped interlocking segments 108 forming the shoulder frame 106 on the side may be of three-eighths inch steel, according to one embodiment.

In another embodiment, the larger circular loop forming the inner band of the closing wheel 210 may be configured using two and/or more larger pieces of the arch-shaped interlocking segments 108 having the radial teeth 110. The smaller outer band of the shoulder frame 106 of the closing wheel 210 may be formed using two and/or more smaller pieces of the arch-shaped interlocking segments 108.

The radial teeth 110 may be a series of annular projections provided at the outer periphery of the closing wheel 210 designed to penetrate the soil 408. The angular tooth design of the radial teeth 110 may help prevent clogging and promote consistent plant emergence. The spiked closing wheel assembly 102 may enable a unique combination of sidewall crumbling and soil firming, according to one embodiment.

An interlocking joint 112 may be an interconnection between the two adjacent arch-shaped interlocking segments 108 forming a metal hoop. Each of the closing wheel 210 may be formed by the three interlocking joints 112 between the three arch-shaped interlocking segments 108, according to one embodiment.

In an additional embodiment, each of the closing wheel 210 may be formed by the two and/or more interlocking joints 112 between the two and/or more arch-shaped interlocking segments 108.

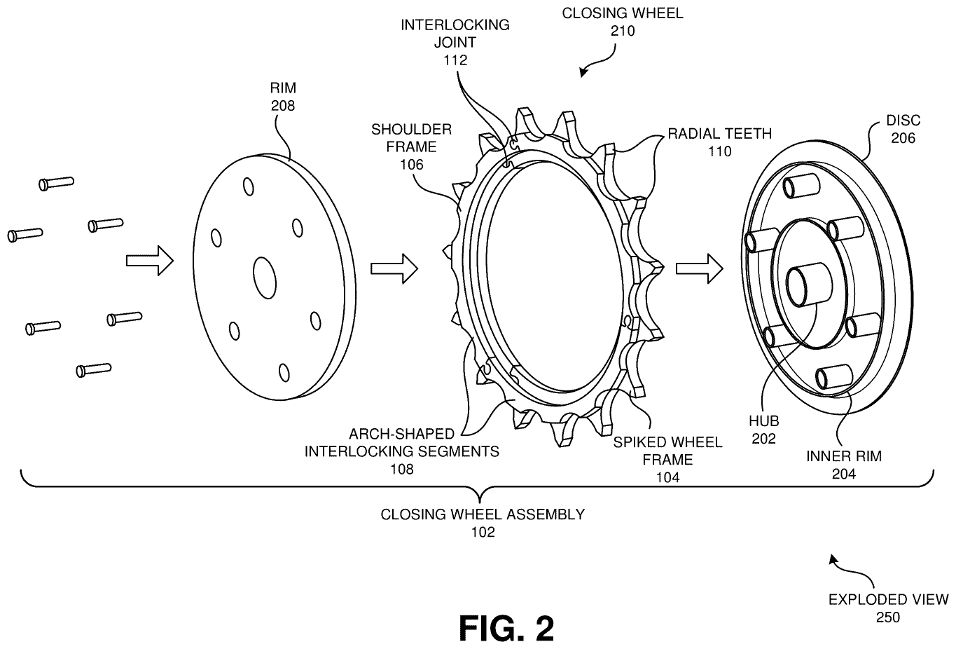

FIG. 2 is an exploded view 250 of the closing wheel assembly 102 of FIG. 1, illustrating the constituting elements of the closing wheel 102, according to one embodiment. Particularly, FIG. 2 builds on FIG. 1, and further adds the hub 202, the inner rim 204, the disc 206, the rim 208, and the closing wheel 210. The hub 202 may be the central part of the closing wheel assembly 102, rotating on or with the axle. The hub 202 may enable the closing wheel assembly 102 to be attached to the planter 404 and allows the closing wheels assembly 102 to freely turn during planting. The inner rim 204 may be an interior periphery of the hub 202 assembly on which the closing wheels 210 are mounted to form the closing wheel assembly 102. The disc 206 may be an outer shield used to fit and cover the closing wheel 210 onto the inner rim 204 of the closing wheel assembly 102.

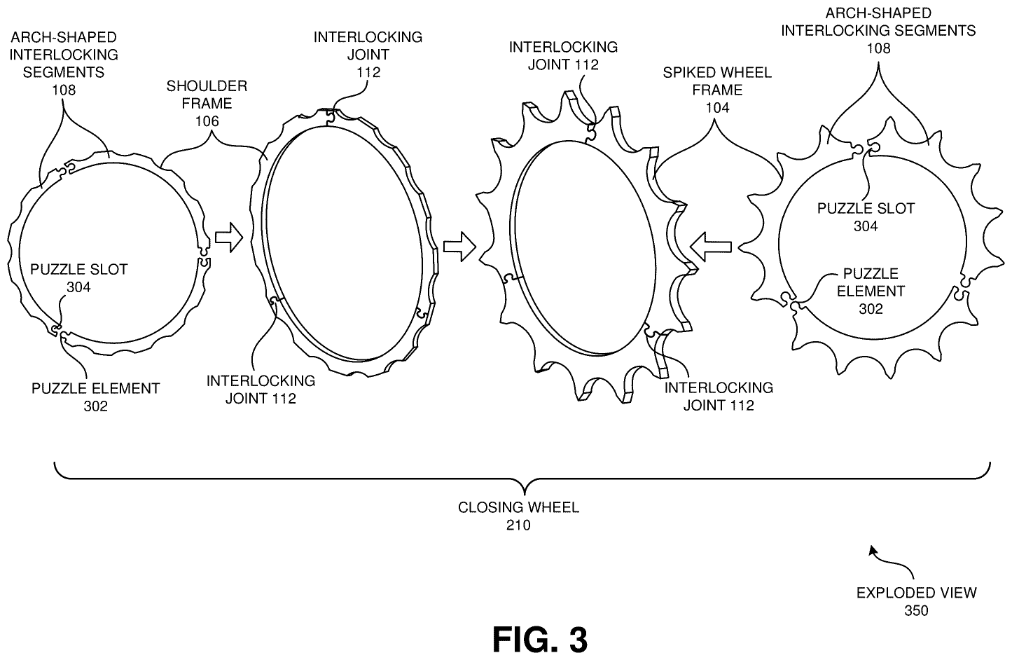

FIG. 3 is an exploded view 350 of the closing wheel 210 of the closing wheel assembly 102 of FIG. 1, illustrating the interlinking of the arch-shaped interlocking segments 108 to form the closing wheel 210, according to one embodiment. Particularly, FIG. 3 builds on FIGS. 1 and 2, and further adds a puzzle element 302 and a puzzle slot 304.

The puzzle element 302 may be a particular riddle-like shape provided at one of the ends of the arch-shaped interlocking segments 108 configured to precisely fit into the puzzle slot 304 provided at another end of the adjacent arch-shaped interlocking segments 108. The puzzle element 302 and the puzzle slot 304 provided at either ends of the arch-shaped interlocking segments 108 may help to interlink the two arch-shaped interlocking segments 108 accurately without requiring welding to form the joints. The two spiked wheel frame 104 and the shoulder frame 106 formed using the puzzle element 302 and the puzzle slot 304 may make the perfect circular loop that does not slip out of its position while handling the closing wheel 210.

In one embodiment, the arc created by the radial teeth 110 of the arch-shaped interlocking segments 108 may not be a pure circle. The arc of the closing wheel assembly 102 may continue to be slightly open when mounted on the planter 404, and then as it approaches the tips; it may open faster to ensure that it becomes more difficult for rocks and/or similar debris to become caught between the radial teeth 110. Additionally, the radial teeth 110 may not be extended out to form a narrower point, hence, it may not create a weak spot to result in breakage if the closing wheel assembly 102 hits a rock in the field.

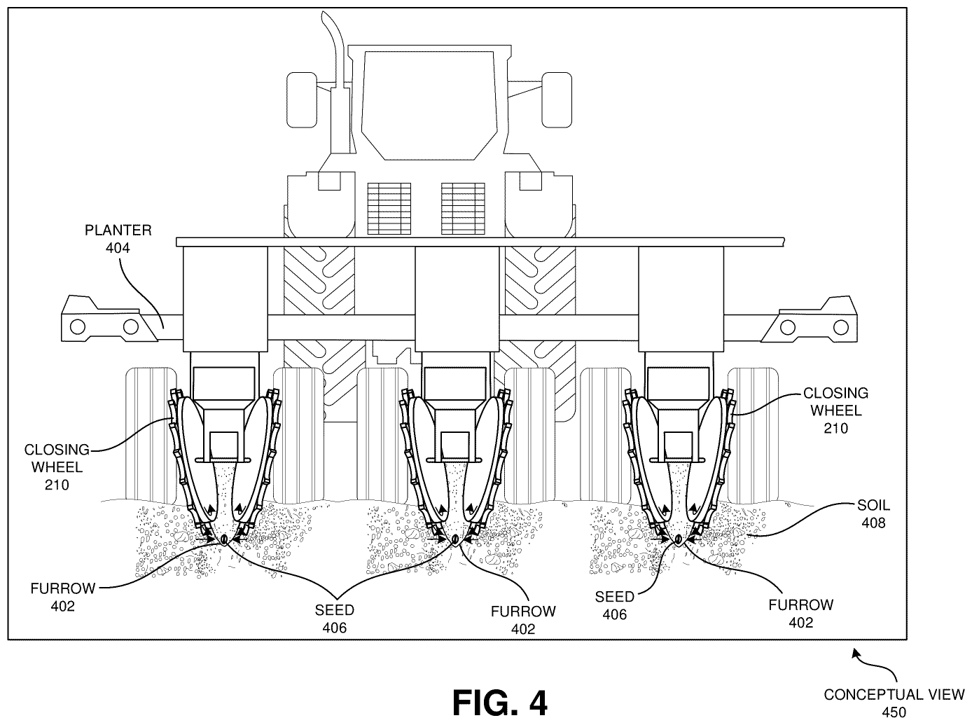

FIG. 4 is a conceptual view 450 illustrating the functioning of the closing wheel assembly 102 of FIG. 1 to optimally cover the seed 406 while planting, according to one embodiment. As displayed in the figure, the set of closing wheels assembly 102 may be mounted at the rear of the planter 404. The planter 404 may open the furrow 402 and place the seed 406 in it. The closing wheel assembly 102 mounted at the rear of the planter 404 may move along the sidewalls of the furrow 402. The radial teeth 110 of the disclosed closing wheel assembly 102 may go into the ground and fracture off the dirt and/or soil 408 into the furrow 402. The shoulder frame 106 of the closing wheel assembly 102 may put just the right amount of the soil 408 at the surface to bring pressure down onto the seed 406 and form the soil layer around the seed 406 to get the best seed-to-soil contact. This may further enable an increased seedling emergence since the seedling may easily push itself through a thin layer of the soil 408. In addition, the roots of the seedling may be able to penetrate through the sidewalls, resulting in an improved root formation and yield.

The disclosed closing wheel assembly 102 may be configured to have wider teeth to displace a sufficient amount of dirt and/or soil 408 into the furrow 402. The shoulder frame 106 of the closing wheel assembly 102 may turn the displaced soil 408 towards the furrow 402 to sufficiently cover the seed 406 for optimum seed-to-soil contact.

In another embodiment, the radial teeth 110 and the shoulder frame 106 may have variable thickness based on soil condition and/or crop requirement. In one more embodiment, the closing wheels 210 may be mounted at a distance of 1.4 to 1.5 inches between the shoulder frames 106 for optimal functioning of the closing wheels assembly 102 to ensure an improved germination and emergence of a crop for higher yield.

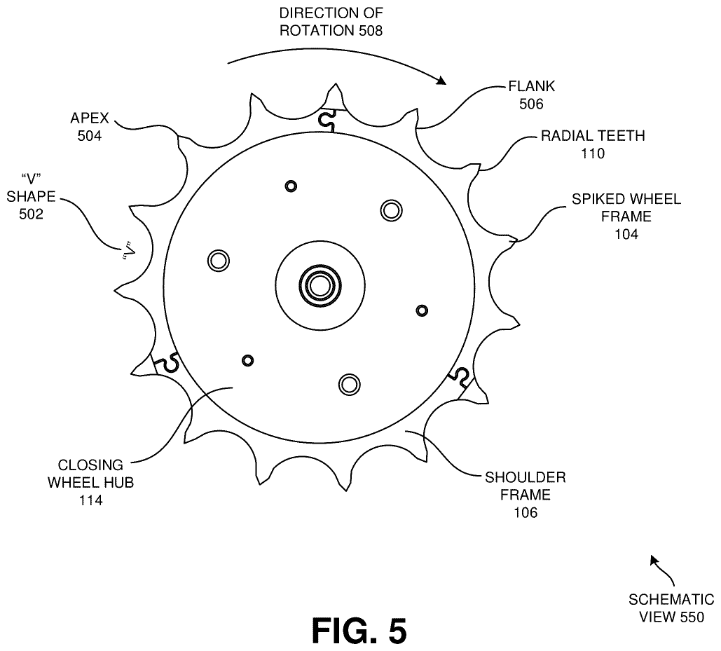

FIG. 5 is a schematic view 550 of the closing wheel assembly 102 of FIG. 1, illustrating a direction of rotation 508 of the assembly and the cooperative action of the radial teeth 110 and the shoulder frame 106, according to one embodiment. As displayed in the figure, the spiked wheel frame 104 of the closing wheel assembly 102 may rotate about a central axis on the closing wheel hub 114. The direction of rotation 508 may refer to the clockwise rotation of the spiked closing wheel assembly 102 during operation. Around the circumference, the radial teeth 110 may be extended outward from the spiked wheel frame 104. Each radial tooth 110 may have a “V” shaped 502 leading profile, analogous to a finger 604, with an apex 504 and a two flanks 506. The apex 504 may be situated at the tip where the “V”-shaped leading profile 502 of the each radial tooth 110 meets to initiate the soil 408 entry beside the furrow 402 in the direction of rotation 508. As the closing wheel 210 turns in the direction of rotation 508, the apex 504 of the each radial tooth 110 may enter the loosened soil 408 beside the furrow 402. The flank 506 may be situated on a respective sloped side of the “V” shaped leading profile 502 extending from the apex 504 toward the spiked wheel frame 104 and is configured to slide along the soil 408 and push it laterally outward from the furrow 402. The shoulder frame 106 may follow the radial teeth 110 and guide the displaced soil 408 for limiting throw and/or smoothing the surface behind the wheel.

The number, spacing, and/or pitch of the radial teeth 110 may provide continuous engagement along the direction of rotation 508 as the one radial tooth 110 leaves the soil 408, the next radial tooth 110 begins to engage. The closing wheel hub 114 may provide mounting and bearing support so the spiked wheel frame 104 turns with low friction while carrying loads from the planter 404 linkage. The included angle and depth of the V-shaped radial teeth 110, together with the contour of the shoulder frame 106, may be selected to achieve the desired lateral displacement of the soil 408 and surface consolidation consistent with the operation, according to one embodiment.

In another embodiment, the width of the radial teeth 110 and the shoulder frame 106 of the closing wheel assembly 102 may be varied based on the crop type and/or soil condition. For larger-seed crops, the width of the shoulder frame 106 may be greater to increase consolidation, while the width of the radial teeth 110 may provide penetration and lateral conveyance. For small-seed crops, both the width of the radial teeth 110 and the shoulder frame 106 may be narrower to reduce disturbance and/or compaction for maintaining gentle closure and uniform seed-to-soil contact.

In an additional embodiment, the number, spacing, and/or pitch of the radial teeth 110 may be configured based on the crop type and/or soil condition to achieve a uniform seed-to-soil contact.

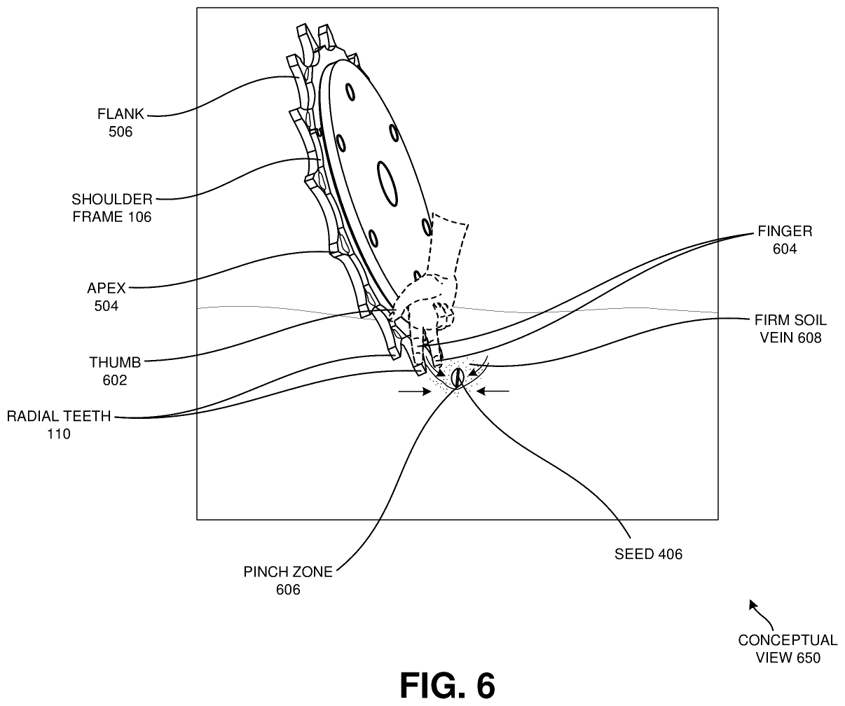

FIG. 6 is a conceptual view 650 of the closing wheel assembly 102 of FIG. 1 illustrating the formation of a pinch zone 606 and a firm soil vein 608 around the seed 406 by the cooperative action of the radial teeth 110 and the inner rim 204 shoulder frame 106 to enhance seed-to-soil contact and/or improve germination, according to one embodiment. The radial teeth 110 may act analogously to fingers 604 to draw the soil 408 inward, while the shoulder frame 106 may act analogously to a thumb 602 to press the drawn soil 408 together to complete a seal above the seed 406, according to one embodiment.

The spiked wheel frame 104 may rotate on the closing wheel hub 114 along with the radial teeth 110 around its circumference. As the closing wheel assembly 102 may advance in the direction of rotation 508, leading edges of the radial teeth 110 may enter the loosened soil 408 on both sides of the furrow 402 to lift the soil 408 from the sidewalls and draw inward toward the seed 406 at the bottom of the furrow 402. The shoulder frame 106 may be provided as an inner rim 204 positioned radially adjacent to the spiked wheel frame 104. As the radial teeth 110 may direct the soil 408 toward the centerline, the shoulder frame 106 may receive the soil 408 and channel it into the defined pinch zone 606. Within the pinch zone 606, a shoulder frame 106 may press the incoming soil 408 together and consolidate the soil 408 directly above and/or around the seed 406, according to one embodiment.

Operation along the furrow 402 may proceed in a repeating sequence. The radial tooth 110 may engage the soil 408 and deliver inward towards the pinch zone 606. The displaced soil 408 may enter the pinch zone 606. The shoulder frame 106 may compress the soil 408 to form the firm soil vein 608. The firm soil vein 608 may extend over and/or around the seed 406. As the one radial tooth 110 may leave engagement, the following radial tooth 110 may begin engagement to maintain inward movement and compaction along the furrow 402, according to one embodiment.

The coordinated interaction of the shoulder frame 106 and the radial teeth 110 may combine the soil-displacing function with the soil-gathering and compressing function. The combined effect may produce a controlled pinching to close the furrow 402, improve seed-to-soil contact, reduce air gaps, and stabilize coverage over the seed placement zone for uniform emergence under field conditions, according to one embodiment.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention.

1. A closing wheel assembly for an agricultural planter, comprising:
a spiked wheel frame having a series of outwardly projected radial teeth configured to penetrate a soil to close a seed trench,
wherein the spiked wheel frame is formed using one or more pieces of steel; and
a shoulder frame situated adjacent to the spiked wheel frame configured to securely mount onto a closing wheel hub,
wherein the shoulder frame to displace the soil towards the seed trench to close the seed trench formed by the spiked wheel frame as the closing wheel assembly rotates through the soil to cover a seed by forming a soil layer around the seed for germination, and
wherein the shoulder frame is radially welded adjacent to the spiked wheel frame to form the closing wheel assembly.

2. The closing wheel assembly of claim 1, analogous to fingers representing the radial teeth of the spiked wheel frame sliding down a “V” shape to displace the soil toward a furrow, and a thumbs representing the shoulder frame moving in coordination to gather the soil and pinch it between each other, the combined action uniquely creates a firm vein of soil at the bottom of the furrow around the seed.

3. The closing wheel assembly of claim 2 to produce more than 1 kg per square centimeter in a firmness directly around and slightly above the seed as measured by a penetrometer.

4. The closing wheel assembly of claim 1, wherein the shoulder frame is configured to form a circular object:
to displace the soil towards the seed trench to enable seed-to-soil contact following the soil layer formed around the seed by the displaced soil, and
to eliminate sidewall compaction through soil firming, eliminate air pockets, and close the seed trench with an inner rim shoulder firming.

5. The closing wheel assembly of claim 1, wherein the spiked wheel frame is configured to have at least one of a width, a shape, and a length of the outward projections of the radial teeth modified depending on at least one of a soil condition and a crop requirement.

6. The closing wheel assembly of claim 1, wherein the spiked wheel frame and the shoulder frame are at least one of a cut steel, a molded steel, a molded plastic, a forged steel, and a forged metal.

7. The closing wheel assembly of claim 1, wherein the shoulder frame is formed by modifying at least one of a width and a depth depending on at least one of the soil condition and the crop requirement.

8. The closing wheel assembly of claim 1, wherein an outermost edge of the shoulder frame is configured to align with a base of the radial teeth of the spiked wheel frame.

9. The closing wheel assembly of claim 1, wherein the width of the radial teeth is half of an inch and the width of the shoulder frame is ⅜th of an inch to displace the soil for at least one of a corn crop, a sunflower crop, a bean crop, and a sorghum crop.

10. The closing wheel assembly of claim 1, wherein the width of the radial teeth is approximately half of an inch and the width of the shoulder frame is approximately a half an inch, and a spike length is shortened to displace the soil for at least one of a bean crop, a cotton crop, a legume crop, and a sugar beet crop.

11. The closing wheel assembly of claim 1, wherein the width of the radial teeth and the width of the shoulder frame is optimized based on a crop type.

12. A method of closing a seed trench in a field, comprising:
providing a closing wheel assembly including a spiked wheel frame having a series of outwardly projected radial teeth and a shoulder frame situated adjacent to a spiked wheel frame, the shoulder frame being secured to the spiked wheel frame by radial welds and configured to mount to a closing wheel hub;
mounting the closing wheel assembly to an agricultural planter;
advancing a planter such that the closing wheel assembly rotates through a soil alongside the seed trench;
penetrating the soil with the radial teeth to displace the soil toward the seed trench; and
using the shoulder frame to gather the displaced soil toward the seed trench and form the soil layer that covers a seed to promote germination.

13. The method of claim 12, wherein the closing wheel assembly operates in coordination with an opposing closing wheel assembly on opposite sides of a V-shaped furrow such that the radial teeth slide down respective sidewalls of the V to pull the soil inward and the shoulder frames move in concert to gather the soil and pinch it between the assemblies, thereby creating a firm vein of soil at or near the bottom of the V-shaped furrow around the seed.

14. The method of claim 12, further comprising producing a firmness of more than 1 kg/cm² directly around and slightly above the seed, as measured by a penetrometer.

15. The method of claim 12, wherein the shoulder frame presents a circular shoulder that, during rotation, displaces the soil toward the seed trench to establish seed-to-soil contact, eliminates sidewall compaction by firming the soil inward, reduces air pockets, and completes the seed trench closure with an inner rim shoulder firming.

16. The method of claim 12, further comprising selecting at least one of a width, a shape, and a length of the outward projections of the radial teeth based on at least one of a soil condition and a crop requirement.

17. The method of claim 12, wherein the spiked wheel frame is formed of one or more pieces of steel and the shoulder frame is radially welded adjacent thereto to form the closing wheel assembly.

18. The method of claim 12, wherein at least one of the spiked wheel frame and the shoulder frame comprises a material selected from a cut steel, a molded steel, a molded plastic, a forged steel, and a forged metal.

19. The method of claim 12, further comprising selecting a width and a depth of the shoulder frame based on at least one of the soil condition and the crop requirement.

20. The method of claim 12, wherein an outermost edge of the shoulder frame is aligned with a base of the radial teeth of the spiked wheel frame.
